(19) United States
(12) Patent Application Publication
(10) Pub. No.: US 2016/0295934 A1
(43) Pub. Date: Oct. 13, 2016

(54) BLUETOOTH-CONTROLLED ELECTRICAL HEATING PAD DEVICE

(71) Applicants: CHIN HUI WU, New Taipei City (TW); Brian Young Ming Kuo, Fremont, CA (US)

(72) Inventor: CHIN HUI WU, New Taipei City (TW)

(21) Appl. No.: 15/075,203

(22) Filed: Mar. 21, 2016

(30) Foreign Application Priority Data
Apr. 10, 2015 (TW) 104205374

(51) Int. Cl. A41D 13/005; H05B 3/54; H05B 1/02; G08C 17/02; A41D 1/00

(52) U.S. Cl. CPC A41D 13/0051; G08C 17/02; A41D 1/002; H05B 1/02; H05B 3/54

(57) ABSTRACT

A Bluetooth-controlled electrical heating pad device includes a clothing body, a Bluetooth control device received in the clothing body, at least one heating device mounted to the clothing body and electrically connected with the Bluetooth control device, a signal feedback module in information connection with the Bluetooth control device and the heating device for detecting a temperature of the clothing body and transmitting a temperature signal to the Bluetooth control device, and an operation device in information connection with the Bluetooth control device. Such an arrangement allows a user to operate the operation device to set the Bluetooth control device and makes use of the signal feedback module to stabilize the temperature of the clothing body caused by the heating device so as to achieve fast rise of the temperature achievable with the clothing body and flexible regulation of the temperature and long keeping the temperature constant.

### TECHNICAL FIELD OF THE INVENTION

The present invention relates generally to a Bluetooth-controlled electrical heating pad device, and more particularly to a Bluetooth-controlled electrical heating pad device, which enables fast heat generation and flexible adjustment of clothing temperature.

### DESCRIPTION OF THE PRIOR ART

Conventional warm-keeping clothing, such as sweaters, jackets, and feather vests, is made of warm-keeping fabrics or wools and, when worn, covers the body of a user. Such cold-protection clothing is not capable of generating heat by itself and provides an effect of warm keeping for the user by only functioning as a barrier, when worn and covering the body of the user, to prevent heat generated by the user from dissipating to the outside. Thus, although the cold-protection clothing may provide an effect of keeping the body of the user warm, since the cold-protection clothing is incapable of generating heat, it would take a period of time before the effect of warm-keeping can be achieved, so that it does not provide a more comfortable heat source temperature and instantaneous heating. This is also true for the recently developed heating clothing because the principle of heating of the heating clothing is based on conversion of water absorbed by polyacrylatic ester into heat or radiation heat generated by body temperature converted by coffee grounds or bamboo charcoal fibers. The two solutions are not considered self-heating of clothing and may have poor response to the temperature of human bodies.

Heating products, such as heat pads and electronic heat pads that are known, although providing an effect of fast heating, do not have a measure of effective control of temperature and may cause undesired burning. The electrical heat pad can be manually shut down to stop heating, yet similar problems still occur often resulting from improper operations. There is clothing that is available in the market and comprising built-in heating devices; however, in addition to the issue of temperature, it suffers laundry cleaning issues.

For example, Taiwan Utility Model M491460 discloses a temperature-controllable heating device, which has a structure composed of a heating pad, a temperature control mechanism, and a battery. The temperature control mechanism comprises a temperature regulation member, a temperature display member, and a microprocessor. The device uses the temperature control mechanism to control the temperature of the heating pad. Although the temperature display member allows for visual observation of the temperature, stabilization of the temperature may only achieved with a collaborative operation of the temperature regulation mechanism and the microprocessor so that it is not possible to achieve an effect of maintaining constant temperature through automatic detection of clothing temperature and feedback of temperature signal. Thus, the same issues as those occurring with the electronic heat pad exist in actual applications.

Thus, the above-discussed warm-keeping clothing suffers the following shortcomings and drawbacks that require further improvements:

(1) The performance of warm keeping is poor and it is impossible to efficiently increase the body temperature of a user.

(2) It is not possible to provide stable and effective control of temperature and thus accident damages, such as burning, may result.

(3) Effective and proper cleaning is inconvenient for clothing with built-in heating devices.

Thus, it is a challenge for the present inventor and those involved in the business to provide a solution for the above problems.

### SUMMARY OF THE INVENTION

The present invention aims to provide a Bluetooth-controlled electrical heating pad device that enables fast heat generation and flexible adjustment of clothing temperature.

An object of the present invention is to enable combination of a heating device to a clothing body and effective control a temperature of the heating device combined with the clothing body to thereby achieve efficient temperature rise and long-kept constant temperature.

Another object of the present invention is using an operation device to control a temperature of a heating device in a wireless Bluetooth manner so as to achieve convenience of operation.

To achieve the above objects, the present invention comprises: a clothing body, a Bluetooth control device received in the clothing body, and at least one heating device mounted to the clothing body and electrically connected with the Bluetooth control device. The Bluetooth control device and the heating device are electrically connected with a signal feedback module. The signal feedback module is provided for detecting a temperature of the clothing body and transmitting a temperature signal to the Bluetooth control device. And, the Bluetooth control device is set in information connection with an operation device. A user, when putting on the clothing body, may operate the operation device to establish, in wireless Bluetooth manner, information connection with the Bluetooth control device and to set a desired temperature and time period for heating. Then, a collaborative cooperation among the Bluetooth control device, the heating device, and the signal feedback module conducts instantaneous detection of the temperature of the clothing body and feeding the temperature signal back for automatically maintaining the temperature of the clothing body.

The technique provided above helps overcome the drawbacks of the prior art where the known warm-keeping clothing has a poor warm-keeping performance, is incapable of fast increasing the temperature of a human body, and may cause safety concern due to being incapable of effectively controlling the temperature and may achieve the above-mentioned objects.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a perspective view of the preferred embodiment of the preferred embodiment taken from a different angle.

FIG. 3 is a block diagram of the preferred embodiment of the present invention.

FIG. 4 is a chart illustrating temperature control of the preferred embodiment of the present invention.

FIG. 5 is a schematic view illustrating use of the preferred embodiment of the present invention.

FIG. 6 is an exploded view illustrating another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

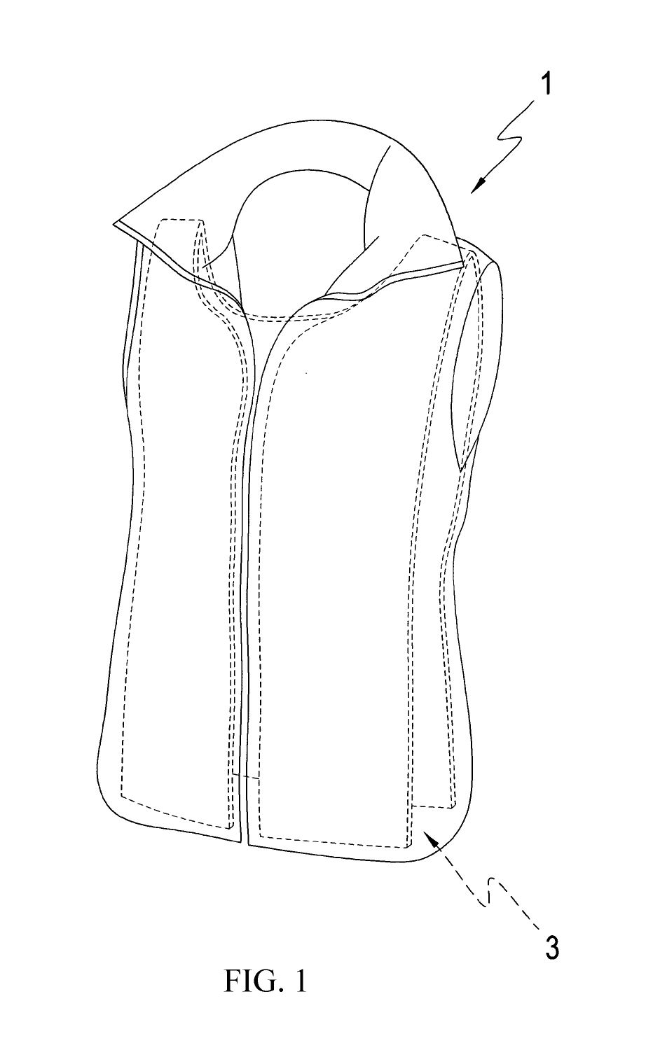

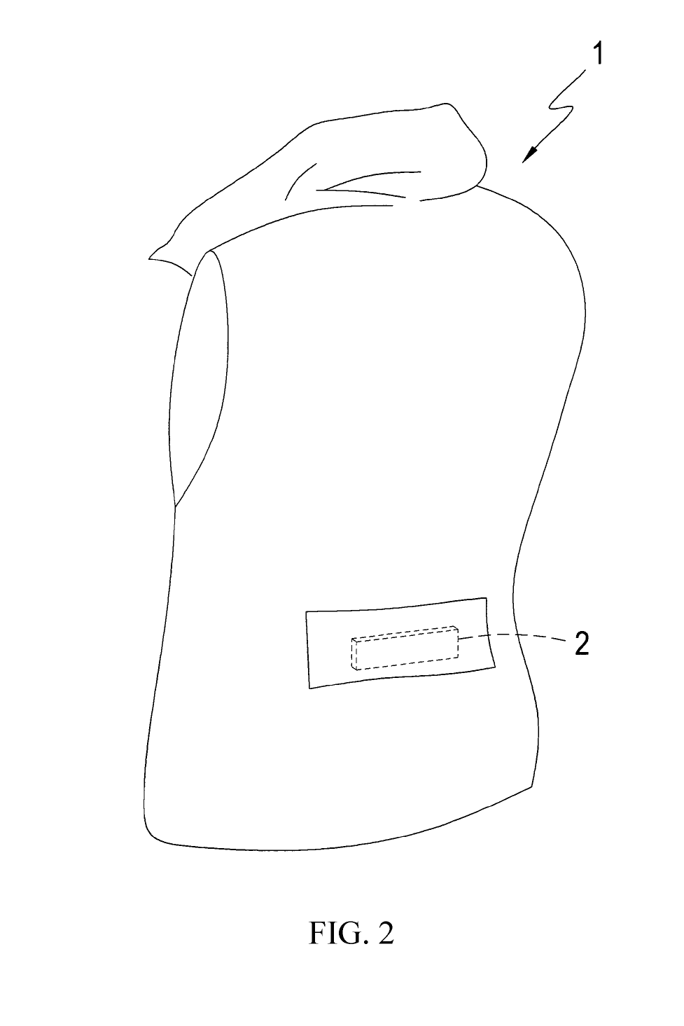

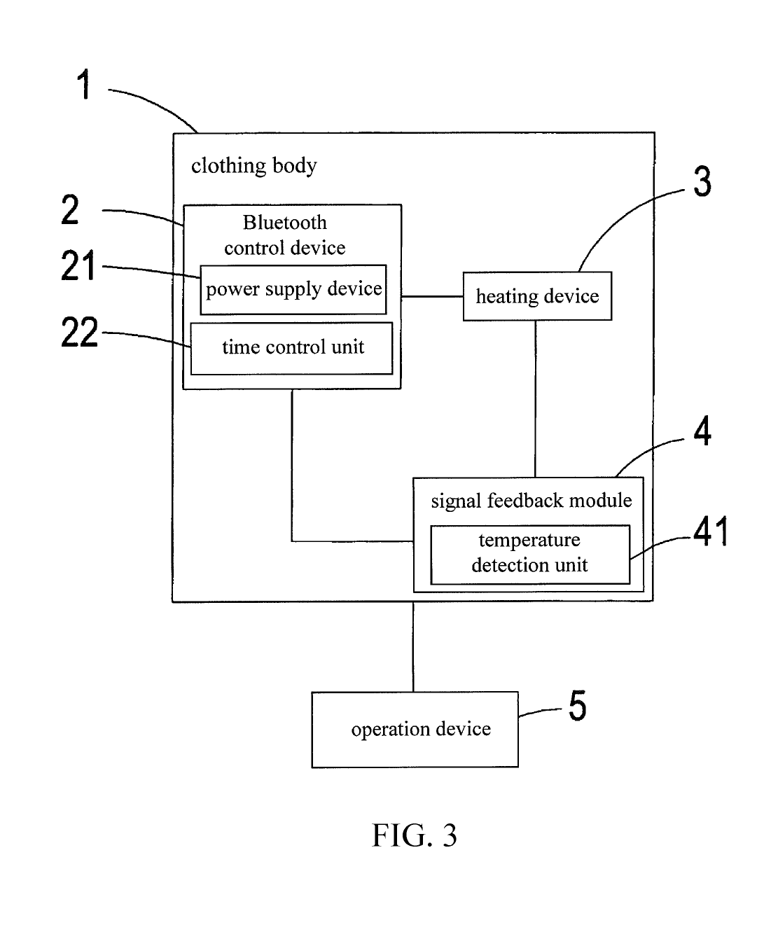

Referring to FIGS. 1, 2, and 3, which are respectively a perspective view of a preferred embodiment of the present invention, a perspective view of the preferred embodiment of the preferred embodiment taken from a different angle, and a block diagram of the preferred embodiment of the present invention, these drawings clearly show that the present invention comprises: a clothing body 1; a Bluetooth control device 2 received in the clothing body 1, the Bluetooth control device 2 being electrically connected with a power supply device 21 received in the clothing body 1, the power supply device 21 being a mobile power supply; at least one heating device 3 mounted to the clothing body 1 and electrically connected with the Bluetooth control device 2, the Bluetooth control device 2 comprising a time control unit 22 electrically connected with the heating device 3 for controlling a time period in which electricity is allowed to supply to the heating device 3; a signal feedback module 4 in information connection with the Bluetooth control device 2 and the heating device 3 for detecting a temperature of the clothing body 1 and generating a temperature signal transmitted back to the Bluetooth control device 2, the signal feedback module 4 comprising at least one temperature detection unit 41 for detecting the temperature of the clothing body 1; and a operation device 5 in information connection with the Bluetooth control device 2, the operation device 5 being one of a smart phone, a tablet computer, and a computer.

The above provides a description of the structure of the present invention. Based on collaboration performed with such a structure, benefits including convenience of operation, efficient temperature rise, effective maintenance of constant temperature, and operation safety may be achieved. Further details are provided in the following description.

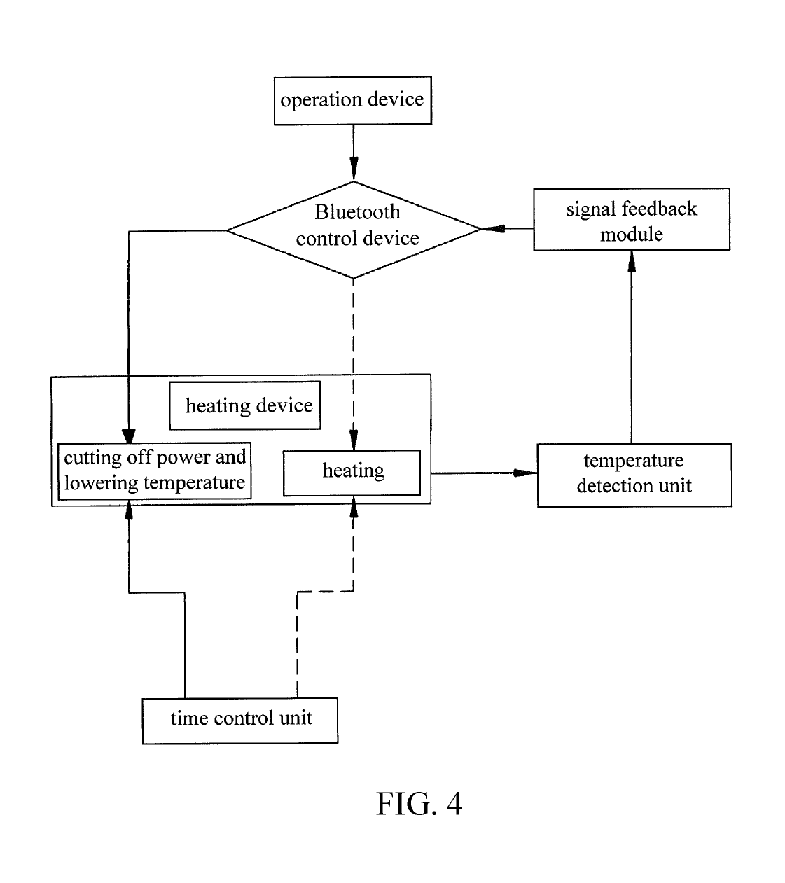

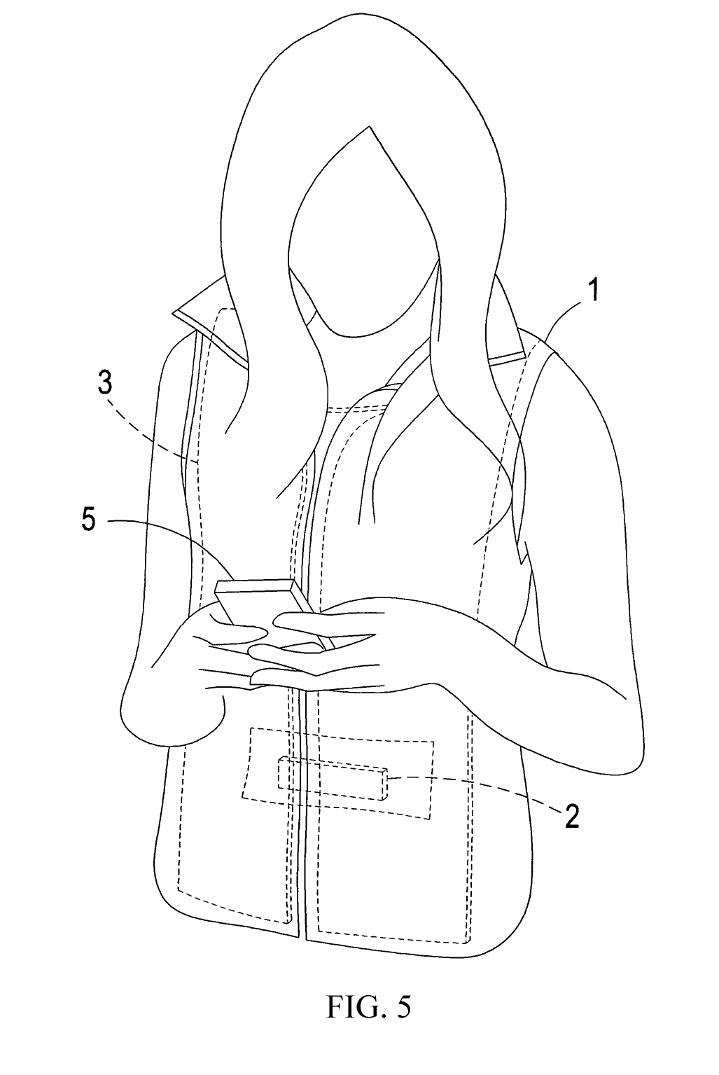

Referring collectively to FIGS. 1-5, which are respectively a perspective view of the preferred embodiment of the present invention, a perspective view taken from a different angle, a block diagram, a chart illustrating temperature control, and a schematic view illustrating the use of the present invention, the drawings clearly show that with the above components are properly assembled, the clothing body 1 receives therein the Bluetooth control device 2, the heating device 3, and the signal feedback module 4 and with collaborative cooperation among the three, instantaneous detection of the temperature of the clothing body 1 may be made and feeding back a temperature signal may be conducted to enable automatic maintenance of the temperature of the clothing body 1. In an actuation application, a user operates the operation device 5 (a smart phone being taken as an example in the instant embodiment and operated with an APP program installed in the smart phone) that is connected, in a wireless Bluetooth manner, to the Bluetooth control device 2 to allow the user to set a desired temperature as the user wishes and to activate a constant temperature mode, where the Bluetooth control device 2 issues a signal to cause the heating device 3 to operate for heating. During the process of heating, the temperature detection unit 41 of the signal feedback module 4 instantaneously and/or constantly detect the temperature of the clothing body 1 and the temperature information is synchronously fed back to the Bluetooth control device 2 via the signal feedback module 4. When the temperature information is higher than the temperature level set by the user (see solid line arrows of FIG. 4), then the heating device 3 is shut down to allow for dropping of temperature; on the other hand, if the temperature information is lower than the level of temperature set by the user (see phantom line arrows of FIG. 4), then the heating device 3 is kept on for further and continuous heating. In this way, a long-term effect of keeping the temperature of the clothing body 1 constant may be achieved and operation safety is also ensured.

Further, the time control unit 22 of the Bluetooth control device 2 may be used to set the heating operation of the heating device 3 to a timed mode so that heating is only conducted by the heating device 3 in a preset period of time. Similarly, the temperature detection unit 41 is set in operation for monitoring the temperature; however, power supply is cut off once the time period so set is reached even if a set temperature level has not been reached (see solid line arrows of FIG. 4); on the other hand, heating is maintained when the time period so set has not bee reached (see phantom line arrows of FIG. 4). Such an arrangement allows for use by a user for staying in a cold environment for a short period of time This provides additional convenience of use. Electricity supply of the present invention is from a power supply device 21, and the power supply device 21 can be a regular mobile power supply, which allows a user to supply electrical power to the present invention, when it is not used for recharging a mobile device and thus, no additional power supply device is necessary. Further, the power supply device 21 can be received in the clothing body 1 to be completely combined with the clothing body 1, providing improved portability and convenience.

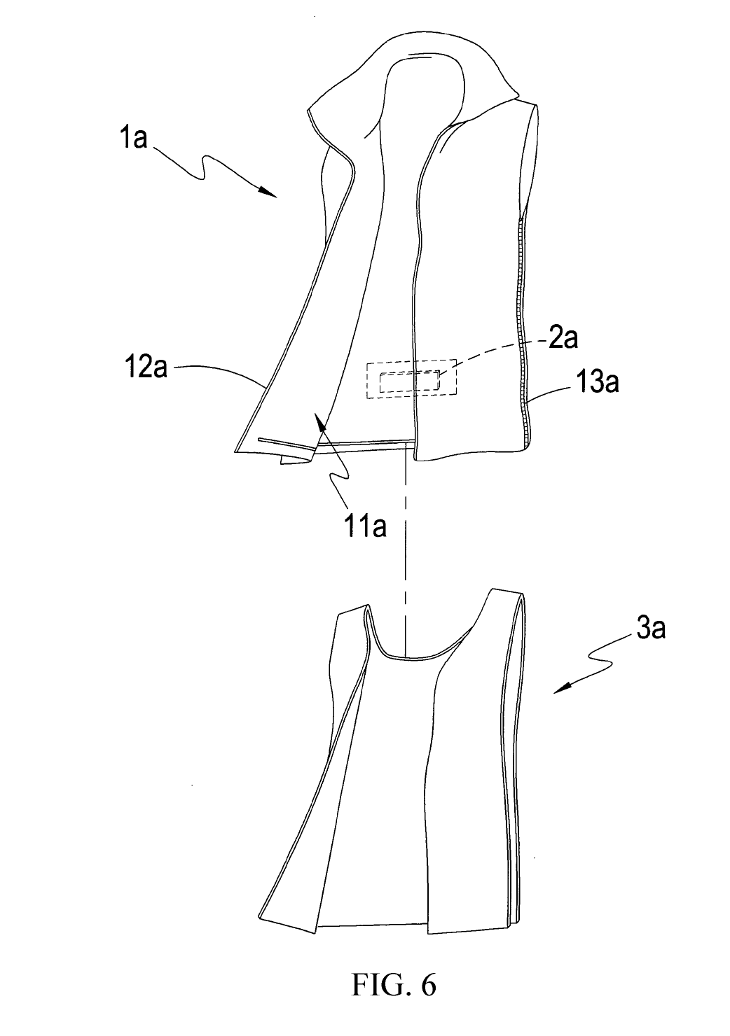

Further, referring to FIG. 6, which is an exploded view of another embodiment of the present invention, the drawing clearly illustrates that the instant embodiment is generally similar to the previous embodiment with only minor modification made on the clothing body 1a, where the clothing body 1a is combined, on an inner side thereof, with a removable lining section 11a to which the heating device 3a is mounted. The removable lining section 11a comprises at least one coupling section 12a, which enables mutual combination between the clothing body 1a and the removable lining section 11a. The clothing body 1a has opposite sides each provided with at least one elastic layer 13a. The coupling section 12a can be one of a zipper, buttons, magnets, and a hook and loop fastener. As such, with the arrangement of the removable lining section 11a and the coupling section 12a, to wash and clean the clothing body 1a, devices, such as the Bluetooth control device 2a, can be readily detached from the clothing body 1a. The elastic layers 13a arranged on the two sides of the clothing body 1a make it possible for widened applications to fit to users having different body sizes and benefiting the production made by the manufacturers.

The above provides only the description of preferred embodiments of the present invention, which are not for constraining the scope of the present invention. Simple modifications and equivalent variations based on the disclosure made in the specification and the drawings are considered within the scope of the present invention defined in the appended claims.

Thus, with reference to all the drawings, the present invention, when put into use, provides the following advantages over the prior art:

(1) A heating device 3 is combined with a clothing body 1 and temperature of the clothing body 1 caused by the heating device 3 can be effectively controlled to achieve the purposes of fast temperature rise, long-term maintenance of constant temperature, and operation safety.

(2) An operation device 5 is operable to control, in a wireless Bluetooth manner, the temperature of the heating device 3 so as to provide convenience of operation.

(3) The arrangement of a removable lining section 11a and a coupling section 12a allows the present invention to be washed and cleaned easily.

(4) The clothing body 1a is provided with elastic layers 13a for accommodating various body sizes so that inventory burden of manufacturer can be reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A Bluetooth-controlled electrical heating pad device, comprising: a clothing body; a Bluetooth control device received in the clothing body; at least one heating device mounted to the clothing body and electrically connected with the Bluetooth control device; a signal feedback module in information connection with the Bluetooth control device and the heating device for detecting a temperature of the clothing body and transmitting a temperature signal to the Bluetooth control device; and an operation device in information connection with the Bluetooth control device.

2. The Bluetooth-controlled electrical heating pad device according to claim 1, wherein the Bluetooth control device is electrically connected to a power supply device received in the clothing body.

3. The Bluetooth-controlled electrical heating pad device according to claim 2, wherein the power supply device comprises a mobile power supply.

4. The Bluetooth-controlled electrical heating pad device according to claim 1, wherein the Bluetooth control device comprises a time control unit electrically connected with the heating device for controlling a period of time in which electrical power is supplied to the heating device.

5. The Bluetooth-controlled electrical heating pad device according to claim 1, wherein the signal feedback module comprises at least one temperature detection unit that detects the temperature of the clothing body.

6. The Bluetooth-controlled electrical heating pad device according to claim 1, wherein the clothing body has an inner side to which a removable lining section is attached for accommodating the heating device.

7. The Bluetooth-controlled electrical heating pad device according to claim 6, wherein the removable lining section comprises at least one coupling section for coupling of the clothing body and the removable lining section to each other.

8. The Bluetooth-controlled electrical heating pad device according to claim 7, wherein the coupling section comprises one of a zipper, buttons, magnets, and a hook and loop fastener.

9. The Bluetooth-controlled electrical heating pad device according to claim 1, wherein the clothing body has two sides each provided with at least one elastic layer.

10. The Bluetooth-controlled electrical heating pad device according to claim 1, wherein the operation device comprises one of a smart phone, a tablet computer, and a computer.
